(19) United States
(12) Patent Application Publication
(10) Pub. No.: US 2025/0345717 A1
(43) Pub. Date: Nov. 13, 2025

(54) Building Blocks for Toy Buildings and/or for Hamster and Small Pet Mazes

(71) Applicant: Eliyah Wadie Ragi Kilada, Portland, OR (US)

(72) Inventor: Eliyah Wadie Ragi Kilada, Portland, OR (US)

(21) Appl. No.: 18/656,604

(22) Filed: May 7, 2024

(51) Int. Cl. A63H 33/04; A01K 1/035; A63H 33/08

(52) U.S. Cl. CPC A63H 33/044; A01K 1/035; A63H 33/086; A63H 33/088

(57) ABSTRACT

This invention provides designs and assembly methods for modular toy building blocks intended for creating customizable mazes for hamsters and small pets. The blocks are easily connectable, enabling various configurations and interactive play. Assembly methods include 3-D snap-together components with optional features for adjusting maze difficulty and size, offering flexibility and engagement for both pets and users.

1. The design for building blocks (and possible assembly) for toy buildings and/or for hamster and small pet mazes is shown and described.

2. There are three building blocks:
a. Floor (which can also act as a ceiling).
b. Side Walls (which can also act as external or internal walls)
c. Connectors (connects floors or ceilings)

3. The Floor/Ceiling Block contains consecutive holes on each of its sides (See FIG. 1). The Side Wall block contains prongs on top and bottom sides (See FIG. 2). The wall prongs interlock with the holes on the floor/ceiling blocks either from the top or from the bottom. Notice that Side Wall prongs are arranged differently on top and bottom such that we allow two different walls to connect to the same floor/ceiling block, one from the top and the other from the bottom creating multiple layers of floors. The prongs would complement each other and not compete on the same holes.

4. Floor/Ceiling Blocks also have long (aka, extension) holes on four sides. Floor blocks connect to each other using Connector Blocks to construct wider and extendible floors and ceilings. Connector Block prongs (See FIG. 3) interlock with the extension holes in the Floor/Ceiling Blocks.

5. Hence, the main floor/ceiling block (FIG. 1) allows interlocking with side walls from top or bottom and on any of its sides. It also has extension holes to connect to other horizontal floor/ceiling blocks. This allows for modular and expandable design in 3 dimensions.

6. We also present different possible assemblies (See FIGS. 9 and 10) where those building blocks can constitute toy buildings or toy mazes. The block size and assembly can be scaled to accommodate different applications, including but not limited to, hamster mazes to help with the whole well-being of the pet and its owners.

### BRIEF DESCRIPTION OF THE DRAWINGS

In the following detailed portion of the present description, the invention with reference to the example embodiments shown in the figures, in which:

FIG. 1 depicts sample Floor/Ceiling Block.

FIG. 2 depicts sample Side/Inner Wall Block.

FIG. 3 depicts sample Connector Block

FIG. 4 depicts sample Quadruple Floor Building Block

FIG. 5 depicts sample Extended Side/Inner Wall Block

FIG. 6. depicts sample Building/Maze Entrance/Exit External Walls

FIG. 7 depicts sample Intermediate Floor with opening

FIG. 8 depicts sample Quadruple Ceiling Building Block

FIG. 9 depicts Sample Maze assembly—View1

FIG. 10 depicts Sample Maze assembly—View2

1. The design for modular building blocks (and possible assembly methods) for toy buildings and/or for hamster and small pet mazes is shown and described.

2. Claim 1 comprises three building blocks:
Floor (which can also act as a ceiling).
Side Walls (which can also act as external or internal walls)
Connectors (connects floors or ceilings)

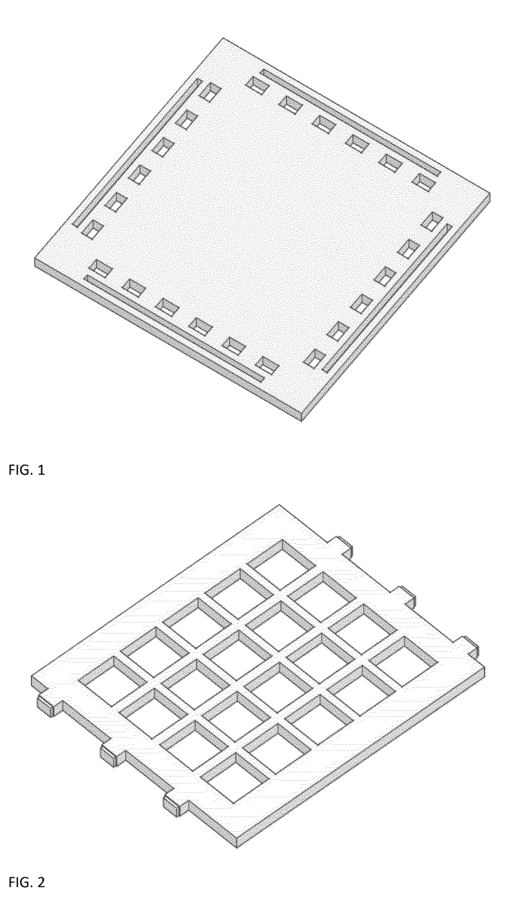

3. The Floor/Ceiling Block of claim 2 contains consecutive holes on each of its sides (See FIG. 1).

4. The Side Wall block of claim 2 contains prongs on top and bottom sides (See FIG. 2).

5. The wall prongs of claim 4 interlock with the holes on the floor/ceiling blocks of claim 3 either from the top or from the bottom.

6. The Side Wall prongs of claim 4 are arranged differently on top and bottom such that we allow two different walls to connect to the same floor/ceiling block of claim 3, one from the top and the other from the bottom creating multiple layers of floors—the prongs would complement each other and not compete on the same holes.

7. Floor/Ceiling Blocks of claim 2 also have long (aka, extension) holes on four sides.

8. Floor blocks of claim 2 connect to each other using Connector Blocks of claim 2 to construct wider and extendible floors and ceilings.

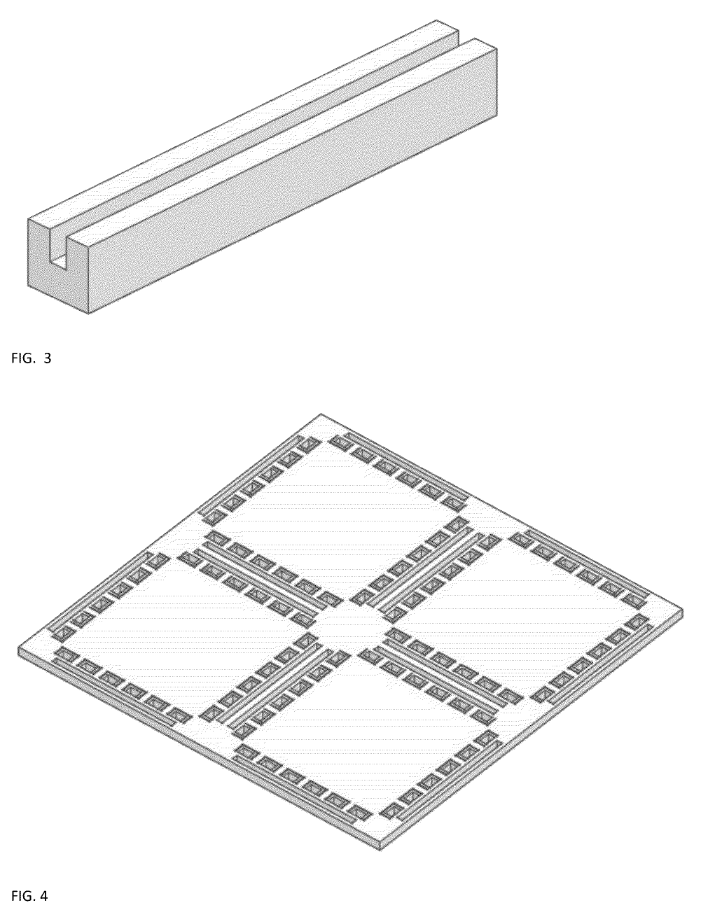

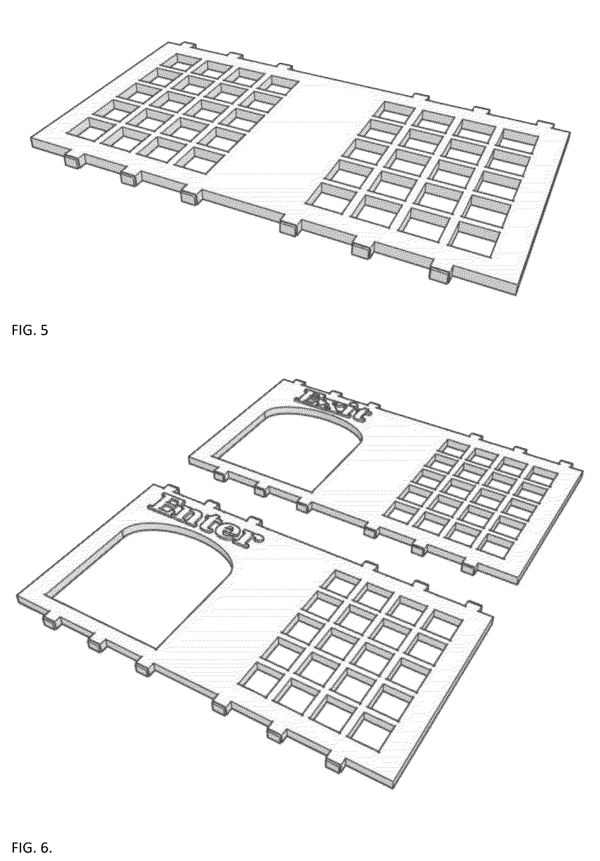

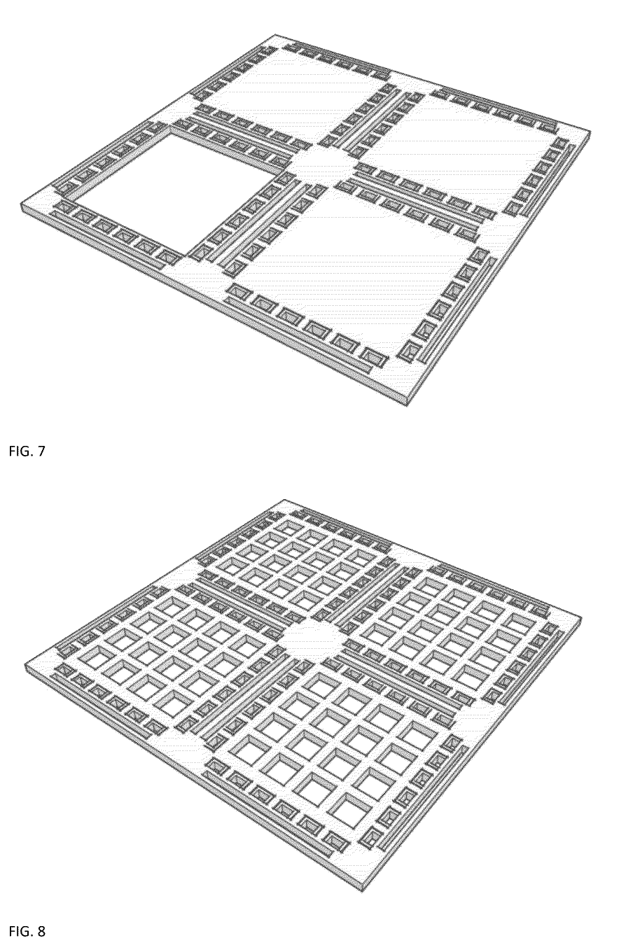

9. Connector Block prongs of claim 2 (See FIG. 3) interlock with the extension holes in the Floor/Ceiling Blocks of claim 2.

10. Hence, the main floor/ceiling block of claim 2 (FIG. 1) allows interlocking with side walls from top or bottom and on any of its sides; it also has extension holes to connect to other horizontal floor/ceiling blocks. This allows for modular and expandable design in 3 dimensions.

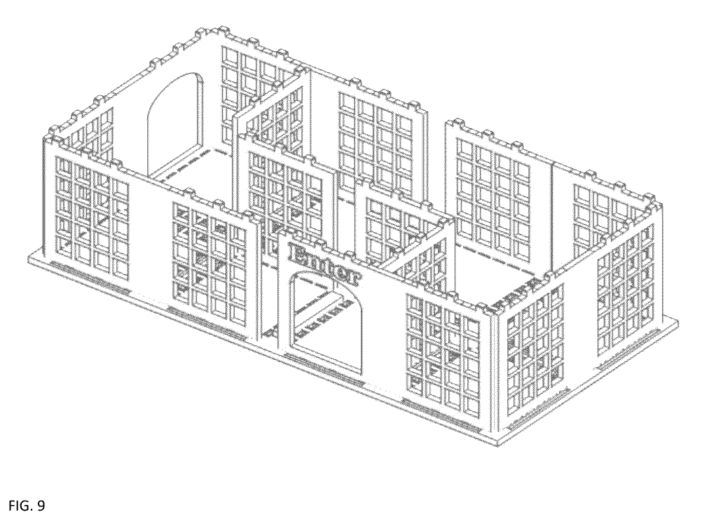

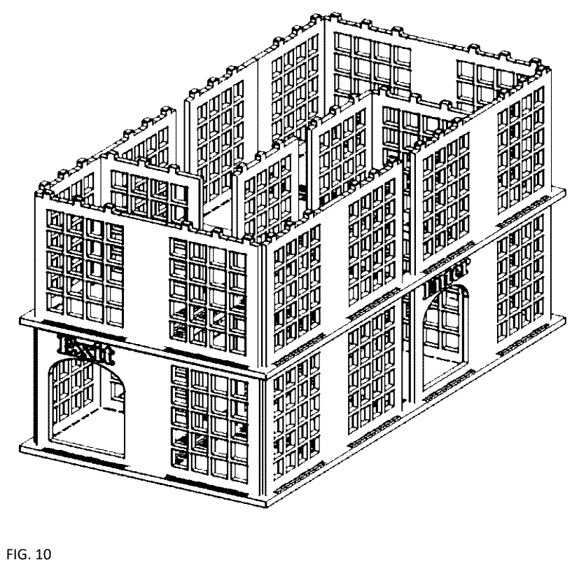

11. We also present different possible assemblies of claim 2 where those building blocks can constitute toy buildings or toy mazes (See FIGS. 9 and 10). The blocks sizes of claim 2 and assembly can be scaled to accommodate different applications, including but not limited to, hamster mazes to help with the whole well-being of the pet and its owners.
